(19) United States
(12) Patent Application Publication
(10) Pub. No.: US 2003/0209612 A1
(43) Pub. Date: Nov. 13, 2003

(54) Spray head for applying a multi-component mixture

(76) Inventor: Kevin Hahnen, Duluth, GA (US)

Correspondence Address: MICHAEL BEST & FRIEDRICH, LLP, ONE SOUTH PINCKNEY STREET, P O BOX 1806, MADISON, WI, 53701

(21) Appl. No.: 10/333,169

(22) PCT Filed: Jul. 17, 2001
(86) PCT No.: PCT/US01/22522

(30) Foreign Application Priority Data
Jul. 17, 2000 (US) 60218599

(51) Int. Cl. A62C 5/00

(52) U.S. Cl. 239/398

(57) ABSTRACT

This invention provides a spray head/applicator (10) for delivering multiple biological fluid agents initially contained in separated containers (11/15) to a surface in an admixed atomized state.

This invention relates to a spray head or spray applicator for delivering a plurality of biological fluid agents, each initially contained in separate containers, to a surface in an admixed state, e.g., a fluid delivery system for delivering bioadhesive agents to a biological tissue.

Treatment of wounds with the living body's own healing components has been found to be very effective in inducing wound closure and subsequent healing. Such treatment includes the use of fibrin sealants and other biological materials in homeostasis, tissue sealing and wound healing. Fibrin sealants are formed from blood plasma components and typically comprise a first agent containing fibrinogen and Factor XIII and a second agent which usually includes a fibrinogen activator such as thrombin and calcium ions, the two agents being mixed together just prior to use. Fibrin sealants, in effect, mimic the last step of the natural coagulation cascade and are usually commercialized as kits comprising the two main agents. After mixing of the agents, the fibrinogen is proteolytically cleaved by thrombin, and converted into fibrin monomers. Factor XIII is also cleaved by thrombin into its activated form which crosslinks the fibrin monomers to form a three-dimensional network that acts as a tissue adhesive or biological adhesive or bioadhesive, and is commonly known as a fibrin clot or fibrin glue. The reaction is rapid and typically commences within a few seconds after the components initially contact one another and attains a soft set after several more seconds of contact. As such, proper mixing and delivery of the components is a challenging technical problem.

Previous attempts to provide fibrinogen and thrombin delivery devices are known. However, there is still a lack of spray application of the fibrinogen and thrombin components in which the components are effectively mixed. Despite recognition and study of various aspects of the problem, the prior art has produced very little in the way of simple and practical techniques for effectively and efficiently mixing and spraying the admixed components.

The present invention provides a spray head or spray applicator for the delivery of a plurality of biologically reactive fluids, e.g., bioadhesive agents or bioadhesive components, in an admixed state which is simple to produce and to use, and which provides homogeneous mixing of the components therein for spray application to a surface.

Other advantages and a fuller appreciation of the specific attributes of this invention will be gained upon an examination of the following drawings, detailed description of preferred embodiments, and appended claims. It is expressly understood that the drawings are for the purposes of illustration and description only, and are not intended as a definition of the limits of the invention.

The preferred exemplary embodiments of the present invention will hereinafter be described in conjunction with the appended drawing wherein like designations refer to like elements throughout and in which:

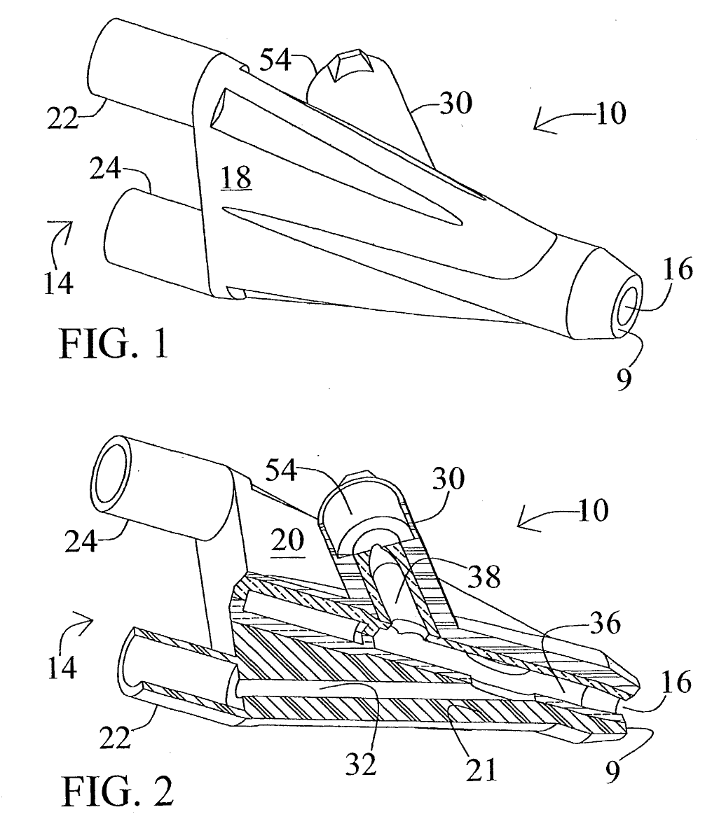

FIG. 1 is a perspective view of the spray head in accordance with the present invention;

FIG. 2 is a perspective view partially exposing the interior portion of the spray head shown in FIG. 1;

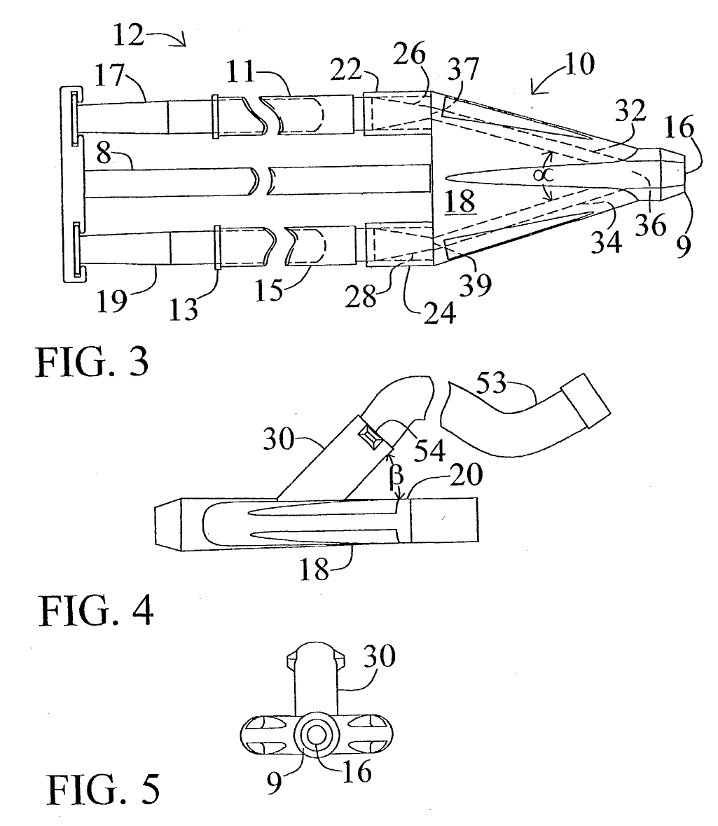

FIG. 3 is a top view of the spray head depicting attachment to a syringe assembly in accordance with the present invention;

FIG. 4 is a side view of the spray head shown in FIG. 1;

FIG. 5 is a front view of the spray head in accordance with the present invention;

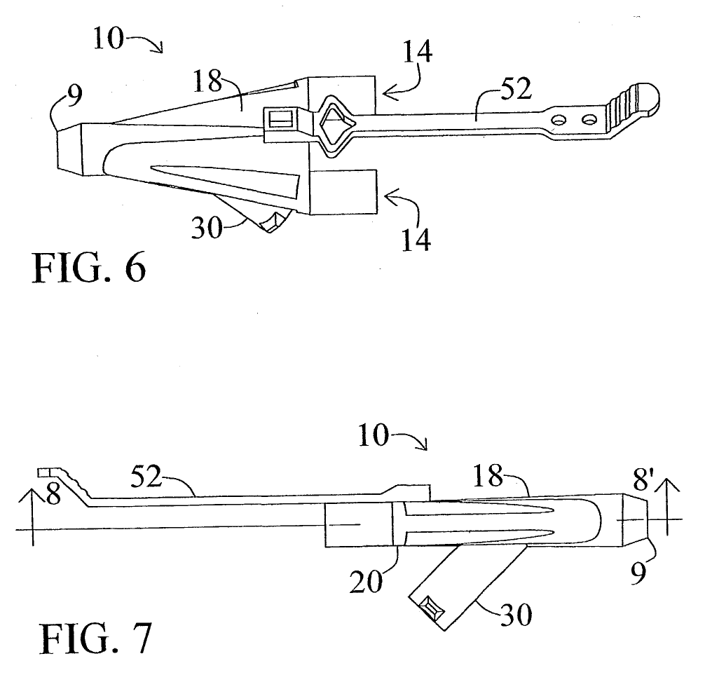

FIG. 6 is a perspective view of the spray head of FIG. 1 shown with a disposable installation strap;

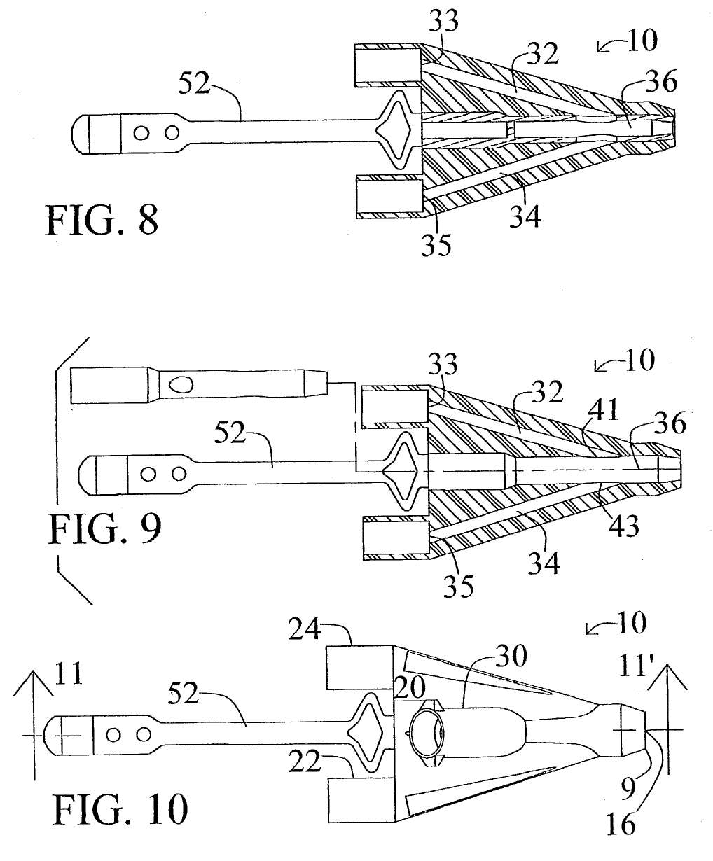

FIG. 7 is a side view of the spray head in FIG. 6; FIG. 8 is a sectional view taken along line 8-8′ in FIG. 7;

FIG. 9 is a partially exploded view of the spray head of FIG. 8;

FIG. 10 is a bottom view of the spray head of FIG. 6;

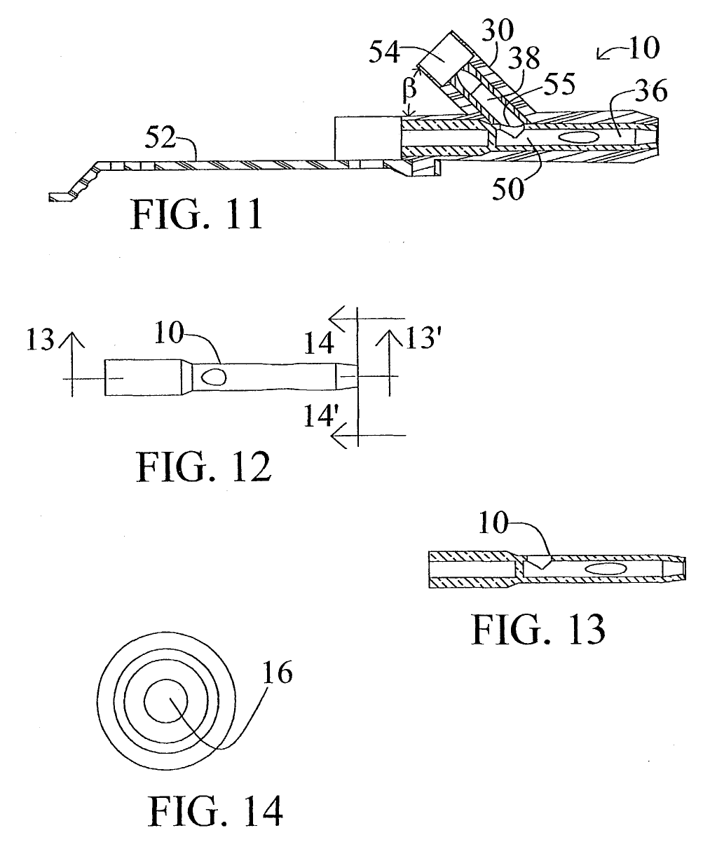

FIG. 11 is a sectional view of the spray head taken along line 11-11′ in FIG. 10;

FIG. 12 is a top view of the central portion of the spray head of FIGS. 1 and 6;

FIG. 13 is a sectional view of the portion illustrated in FIG. 12 taken along line 13-13′; and

FIG. 14 is a sectional view of the portion illustrated in FIG. 12 taken along line 14-14′.

The present invention is particularly adapted for use as a spray head, spray applicator or spraying device for the mixing, atomization and discharge of components or agents which are individually delivered to the spray head from a fluid delivery device or system. Accordingly, the present invention will now be described in detail with respect to such endeavors; however, those skilled in the art will appreciate that such a description of the invention is meant to be exemplary only and should not be viewed as limitative on the full scope thereof.

The invention provides a medication dispensing device for dispensing a plurality different, i.e., separate, fluid medications or agents as an admixed product. The device is in the form of a spray head that is useful for dispensing a mixture of a plurality of fluids in which the plurality of fluids is mixed to form a viscous mixture immediately before use. For example, the invention provides a method and apparatus for delivering two biochemically reactive liquids in an admixed state, e.g., fibrinogen and thrombin to form fibrin. These biochemically reactive fluids may be delivered topically, in open-type surgeries such as laparotomic procedures, and in minimally invasive surgeries such as laparoscopic procedures.

In one embodiment, the invention is a spray head suitable for attachment to, and use with, a supply device for application of a mixture of two or more separate fluid components to a surface. The spray head suitably includes a housing and a channel contained within the housing. The channel has two or more branched portions and a common portion. Each branched portion has an entry port for receiving a fluid component and an exit port into the common portion. The entry ports are attachable to the supply device for dispensing each of the separate components into the branched channels. The common portion is for receiving and mixing the components to form a mixture and has a common portion exit port. The spray head also includes a gas channel for carrying gas into the common portion for atomizing and propelling the mixture through the common portion exit port.

In another aspect, the invention is a system for mixing and delivering two or more fluids as an admixed composition, the fluids being admixed just prior to application to a surface. In this embodiment, the system includes a syringe assembly and a discharge assembly. The syringe assembly includes syringes for holding and dispensing each fluid. Each syringe has a syringe body and a fluid exit tip. Each tip has an exit channel terminating in an exit port. The tips are adjacent and substantially parallel to each other. The discharge assembly is for receiving fluid from each exit port, for mixing the fluid from both of the ports and for delivering the mixed composition in a spray, and is coupled to the exit ports of the syringe assembly. The discharge assembly includes a spray head having channels therethrough communicating with the exit ports from the syringe assembly, for carrying each fluid in its corresponding channel within the spray head. The spray head also includes a mixing chamber having an exit opening, to receive and mix the separate flows from the channels; and a gas line having an exit port, for carrying a pressurized gas to the mixing chamber. The fluids are mixed in the mixing chamber to form a mixed composition that is immediately atomized and entrained by the gas and discharged in a spray from the exit opening.

Reference is now made to the figures of the drawing, FIGS. 1-14, wherein an illustrated embodiment of a spray head, spray applicator or sprayer member in accordance with the present invention is depicted and generally designated by reference numeral 10. Spray head 10 is removably attached or connected to a fluid delivery device, generally designated as reference numeral 12, having separate fluid delivery containers/vessels.

In an illustrated embodiment (partially shown in FIG. 3), delivery device 12 is suitably a dual syringe assembly 13 having syringes 11 and 15 which have syringe tips 26 and 28, respectively, and syringe pistons 17 and 19, respectively. The syringes of assembly 13 contain and hold the fluid components to be mixed and are arranged in a parallel fashion. Typically, the syringes are commonly held and can be actuated by common means, e.g., a trigger or plunger 8, to commonly actuate the pistons within each syringe. In providing a fibrin adhesive/sealant as the mixed product, one syringe contains a fibrinogen component/solution and the other a solution of fibrinogen activator such as thrombin. Other containers (e.g., fluid containers other than syringes, more than one container, etc.) are also possible for use with spray head 10.

Spray head 10 includes a connector end or inlet end 14 for connecting to a supply of solution components to be mixed and an exit end 9 which has an exit opening 16 from which the mixed product is delivered, i.e., is ejected, expelled, discharged or propelled. Spray head 10 has a top 18, which is suitably flat, a bottom 20, which is suitably substantially flat or planar, and an interior 21. Connector end 14 includes a pair of conventional, e.g., sleeve-like, connectors 22 and 24 which receive syringe tips 26 and 28. Syringe tips 26 and 28 are suitably friction fit or press fit into connectors 22 and 24, respectively, although other known attachment or interlocking systems can be used. Syringe tips 26 and 28 have exit openings or ports 37 and 39, respectively, through which the contents of the syringes flow upon being delivered from the syringes.

A partial cut-away side view of the spray head 10 in accordance with the present invention is shown in FIG. 2. Cross-sectional views of the interior of spray head 10 are illustrated in FIGS. 8, 9, 11 and 13. The interior 21 of spray head 10 includes a mixing chamber 36 and component conduits or channels 32 and 34 having syringe-connecting or inlet ports, 33 and 35, respectively, and mixing-chamber connecting or exit ports, 41 and 43, respectively. Ports 33 and 35 are aligned with syringe exit openings or ports 37 and 39 of syringe tips 26 and 28, respectively. Channels 32 and 34 lead from syringe tips 26 and 28 to and end at mixing chamber 36 which is proximate the exit opening 16. In an illustrated embodiment, channels 32 and 34 are suitably disposed at an acute angle α to each other (although larger angles are suitably contemplated) and converge at the mixing chamber 36. In other words, in the illustrated embodiment, the internal or interior channels of head 10 form, in effect, a Y-shaped configuration in which the arms of the Y are the conduits 32 and 34 and the base or leg is the mixing chamber 36. Conduits 32 and 34 provide fluid communication between the syringes and the mixing chamber.

As best seen in FIGS. 4, 5 and 11, mixing chamber 36 has a distal end 50, and spray head 10 also includes a connector or conduit 30 for connection to a gas line 53 for a supply (not shown) of sterile gas, e.g., compressed air, nitrogen or carbon dioxide. Connector 30 is suitably disposed in spray head 10 at an acute angle β (although larger angles are suitably contemplated) to bottom 20, i.e., to the substantially planar bottom 20. Connector 30 has a gas inlet port 54 and an interior gas supply channel 38. Connector 30 conducts gas through head 10 to mixing chamber 36. Gas is delivered into chamber 36 through an exit port 55. Channel 38 ends proximate the distal end 50 of mixing chamber 36.

As best seen in FIGS. 6-11, an installation strap 52 is provided to facilitate attachment of spray head 10 to syringe tips 26 and 28. Strap 52 is readily detachable and disposable from head 10 if desired.

In operation of the illustrated embodiment, the syringes are filled with the component solutions to be mixed. In the case of a fibrin sealant, one syringe suitably contains a fibrinogen solution and the other a thrombin solution. Pressure is applied to the plunger 8 of the syringes, causing the solutions in the syringes to flow into the channels 32 and 34. The two solutions flow through their respective channels to meet in mixing chamber 36 where the solutions are mixed to form an admixed product or composition. The two solutions suitably enter the mixing chamber 36 in separate streams at angle α to each other, facilitating mixing the solutions. Gas flow is released via connector 30 and through channel 38 into mixing chamber 36, mixing with the mixed composition. The mixed composition is atomized and entrained in the gas flow and emerges from exit opening 16. After a sufficient amount of the mixture composition has been applied to a target surface, the pressure on the plunger 8 is stopped and component flow ceases. Gas, however, can continue to flow along gas channel 38 into the mixing chamber 36 and out exit opening 16, thereby purging any residual coagulating mixture remaining in the mixing chamber.

Spray head 10 is suitably made of a one-piece or unitary construction. Materials for the spray head are not particularly limited but are suitably made of a common synthetic material used in the medical field, such as polyolefin (polyethylene, polypropylene), polyurethane, PVC, ACS (acrylonitrile butadiene styrene), or polyester, by injection molding or by extrusion or can be made of metal or a combination of polymer and metal, e.g., the housing of the head may be polymeric while the interior channels may be metal. Conduits 32 and 34 are suitably made of Teflon™, polymeric material, metal or the like.

The source of gas/air can be a line from a remote source or a cartridge attached to head 10 via connector 30. The gas is typically actuated in a common manner with component actuation (e.g., syringe actuation) or may have independent gas actuation.

It is noted that many fibrinogen and thrombin compositions or solutions are known with varying concentrations and including other ingredients. Fibrinogen or thrombin compositions useful in preparing wound sealants or bioadhesives are suitably used with the spray head of the present invention. Fibrinogen-containing solutions are typically obtained from plasma separated from anticoagulated whole blood by density difference fractionation (e.g., by gravity or centrifugation). Generally, the fibrinogen content of such solutions is between about 2 mg/mL to about 115 mg/mL. Fibrinogen activators such as thrombin are well known and commercially available. In addition, a variety of additional components can be added to the fibrinogen or fibrinogen activator solutions to enhance, facilitate or modify the characteristics of the coagulum, e.g., blood factors such as Factor XIII, a fibrin cross-linking factor. Others include antifibinolytics, platelets, calcium, ground bone and antibiotics.

It is also noted that the fluid delivery system, e.g., the syringe assembly, may have fluid delivery vessels, e.g., syringes, of identical or different cross-sections which may deliver the same or different volumes of fluid to the spray head.

In summary, the present invention provides a spray head for delivery of a multi-component composition in which the components are mixed just prior to application and a spray of the admixed components is delivered onto a target, e.g., a biological surface.

While the present invention has now been described and exemplified with some specificity, those skilled in the art will appreciate the various modifications, including variations, additions, and omissions that may be made in what has been described. Accordingly, it is intended that these modifications also be encompassed by the present invention and that the scope of the present invention be limited solely by the broadest interpretation that lawfully can be accorded the appended claims.

I claim:

1. An apparatus comprising a one-piece construction spray head having a connector end, a delivery end opposite the connector end, a gas supply line connector, component conduits, a mixing chamber and a gas channel;
the connector end for connecting to a supply of components to be mixed;
the delivery end having an exit opening for delivering mixed components;
the gas supply line connector for connecting to a pressurized gas supply;
component conduits for conveying the components to the mixing chamber, each conduit having an exit port into the mixing chamber;
the gas channel operatively connected to the gas connector and the mixing chamber, for conveying a gas to the mixing chamber;
the mixing chamber being proximate the delivery end, for receiving and mixing the components and for receiving the gas to discharge the mixed components out through the exit opening.

2. An apparatus as claimed in claim 1, wherein the exit ports of the component conduits are angled with respect to each other.

3. An apparatus as claimed in claim 2, wherein the component conduits and mixing chamber together form a Y-shaped configuration.

4. An apparatus as claimed in claim 1, wherein the spray head has a substantially planar bottom.

5. An apparatus as claimed in claim 4, wherein the gas supply line connector is angled with respect to the planar bottom.

6. An apparatus as claimed in claim 4, wherein the gas supply line connector is configured to be at an acute angle with the planar bottom of the spray head.

7. A method of delivering a plurality of components as an admixed product, comprising connecting containers of the components to a spray head having a connector end and a delivery end; delivering the components from their containers into the spray head via conduits to a mixing chamber; mixing the components in the mixing chamber to form the admixed product; supplying a line of pressurized gas to the mixing chamber and discharging the admixed product out the delivery end of the spray head.

8. A method as claimed in claim 7, further comprising purging the mixing chamber with gas after discharging the admixed product.

9. A method as claimed in claim 7, wherein the components include a fibrinogen solution and a fibrinogen activator solution.

10. A method of making a spray head for a system for mixing and delivering a plurality of separate components as mixed components, comprising providing a conduit aligned with and connected to a delivery end of each of a plurality of containers, each container containing a component to be mixed; disposing the conduits such that they converge in a mixing chamber to form mixed components; providing a line of pressurized gas to the mixing chamber; and providing an exit opening in the mixing chamber through which the mixed components are expelled.

11. An apparatus for spraying a fluid mixture comprising:
first and second syringes, each having an outlet for supplying first and second fluids;
a spray head having first and second channels in communication with the first and second fluids;
a mixing chamber downstream from the first and second channels into which the first and second channels converge, for mixing first and second fluids carried in the first and second channels into a fluid mixture;
a gas channel for carrying a gas into the mixing chamber; and
an exit opening in the mixing chamber through which the fluid mixture is propelled.

12. An apparatus as claimed in claim 11, wherein the first fluid is a fibrinogen solution and the second fluid is a fibrinogen activator.

13. A spray head suitable for attachment to and use with a supply device for application of a mixture of two or more separate fluid components to a surface, the spray head, comprising:
a housing;
a channel contained within the housing, the channel having two or more branched portions and a common portion, each branched portion have an entry port for receiving a fluid component and an exit port into the common portion;
the entry ports attachable to the supply device for dispensing each of the separate components into the branched portions;
the common portion for receiving and mixing the components to form a mixture and having a common portion exit port;
a gas channel for carrying gas into the common portion for atomizing and propelling the mixture through the common portion exit port.

14. A system for mixing and delivering an admixed composition of two or more fluids immediately prior to application to a surface, comprising:
a syringe assembly having syringes for holding and dispensing each fluid, each syringe having a syringe body and a fluid exit tip, each tip having an exit channel terminating in an exit port, the tips being adjacent and substantially parallel to each other;
a discharge assembly coupled to the exit ports of the syringe assembly for receiving fluid from each exit port, for mixing the fluid from both of the ports and for delivering the mixed composition in a spray; the discharge assembly comprising a spray head having channels therethrough communicating with the exit ports from the syringe assembly, for carrying each fluid in its corresponding channel within the spray head; a mixing chamber having an exit opening, to receive and mix the separate flows from the channels; and a gas line having an exit port, for carrying a pressurized gas to the mixing chamber, wherein the fluids are mixed in the mixing chamber to form a mixed composition which is immediately atomized and entrained by the gas and discharged in a spray from the exit opening.
